(19) United States
(12) Patent Application Publication
(10) Pub. No.: US 2007/0222092 A1
(43) Pub. Date: Sep. 27, 2007

(54) Mold for Injection Molding Light Guide Plate and Process for Producing Light Guide Plate Using the Mold

(76) Inventors: Masahiko Hayashi, Takaoka-shi (JP); Kazunori Ueki, Takaoka-shi (JP); Satoshi Tazaki, Sagamihara-shi (JP); Kazuyuki Obuchi, Yokohama-shi (JP)

Correspondence Address: BIRCH STEWART KOLASCH & BIRCH, PO BOX 747, FALLS CHURCH, VA, 22040-0747, US

(21) Appl. No.: 10/594,615

(22) PCT Filed: Mar. 28, 2005
(86) PCT No.: PCT/JP05/06539

§ 371 Date: Sep. 28, 2006

(30) Foreign Application Priority Data
Mar. 31, 2004 (JP) 2004-106758

(51) Int. Cl. B29D 11/00

(52) U.S. Cl. 264/1.1; 425/542

(57) ABSTRACT

Molds for injection molding a light guide plate in which a plurality of pin gates and/or film gates for injecting a melted resin material for molding into the cavity portion are formed at portions corresponding to the side portions of the product, a room for balancing flow having an ear shaped portion to which the material is supplied is disposed between each gate and a sprue or a runner, and the area of each gate is set so that the temperature of the material introduced into the cavity is higher than that supplied to each room by at least 5° C. due to heat generated from shearing when the material passes through the gate; and a process for producing a light guide plate using the molds. Formation of weld lines, sink marks, flow marks and warp is suppressed, and a product exhibiting excellent quality without the necessity of steps of gate cutting and finishing can be obtained.

### TECHNICAL FIELD

The present invention relates to a mold for injection molding a light guide plate and a process for producing a light guide plate using the mold. More particularly, the present invention relates to a mold for injection molding a light guide plate suppressing formation of weld lines, sink marks, flow marks and warp and providing a product of injection molding exhibiting excellent quality without the necessity of steps of gate cutting and finishing and a process for producing a light guide plate using the mold.

### BACKGROUND ART

Liquid crystal display devices are widely used for personal computers, flat panel televisions and panels for carnavigations. As the back light device for liquid crystal display devices, the back light device of the edge light type in which a tubular light source is placed in the edge portion of a light guide plate and the back light device of the direct type in which a tubular light source is placed directly under the face of display via a light diffusion plate are widely used. The back light of the edge light type is a device in which a light source such as a cathode ray tube is placed on the face receiving incident light at an edge portion of the light guide plate which is formed with a transparent acrylic resin or the like by injection molding, and a back light device having a small thickness can be prepared. However, a product formed by injection molding inevitably has marks formed by a gate, which adversely affects obtaining a uniform face of display due to unevenness in luminance. Therefore, various attempts have been made to prevent the adverse effects of the marks formed by a gate. With respect to the position of the gate, a process of injection molding in which a gate is formed in a face receiving incident light, a face opposite to the face receiving incident light and a side face adjacent to the face receiving incident light is proposed.

For example, as the process for producing inexpensively a light guide plate which can provide uniform output light using a conventional molding machine and under conventional conditions without forming weld lines or warp even when the light guide plate has an extremely small thickness, processes for producing a light guide plate for a planar light source device are proposed which comprise preparing a mold for molding a light guide plate by disposing in said mold a gate at a projecting portion extending from the face receiving incident light disposed at an approximately central position of the face receiving incident light in the longitudinal direction and additionally forming a cavity into which a melted material is injected through said gate to make the melted material flow approximately symmetrically toward the longitudinal directions of the face receiving incident light; molding the light guide plate using said mold; and then cutting off the projecting portion formed by the additionally formed cavity or unnecessary portions (Patent Reference 1 and Patent Reference 2).

As the mold for injection molding which prevents concentration of the filling pressure and fluctuation in the filling when a cavity for molding is filled by injection of a melted resin material, provides a light guide plate having excellent quality with stability without defects such as sink marks and flow marks, and facilitates the post-treatment of the gate, a mold for injection molding in which a gate portion for injecting a melted resin material for molding and filling the cavity for molding a light guide plate is formed at the end face of the light guide plate having a smaller thickness, a film gate structure is adopted for the gate portion, and the gate portion having a length of ½ or longer is formed in the longitudinal direction of the end face having a smaller thickness, is proposed (Patent Reference 3). In the lighting device used for liquid crystal devices of the reflection type which is constituted with a light source and a light guide, a device having marks of gates at the side face of the light guide plate adjacent to the face receiving incident light is proposed as the device in which interference fringes observed from the side of the upper face of the light guide plate are thin, and fluctuation in the interference fringes due to roughness such as marks of gates formed by cutting does not arise, (Patent Reference 4).

However, the above processes have a problem in that the cycle time increases since a step of cutting off the gate portions from the product formed by the molding and, occasionally, a surface treatment such as polishing are necessary. The effect of suppressing weld lines is not always sufficient. When the film gate was formed at a portion corresponding to the face at the side having a smaller thickness, the cutting is not satisfactorily conducted, occasionally, because the strength of the face having a smaller thickness is low.

[Patent Reference 1] Japanese Patent Application Laid-Open No. Heisei 8 (1996)-68910 (pages 2 and 3, FIG. 1)

[Patent Reference 2] Japanese Patent Application Laid-Open No. 2001-96583 (pages 2 and 3, FIG. 1)

[Patent Reference 3] Japanese Patent Application Laid-Open No. 2002-292690 (pages 2, 3 and 7, FIG. 1)

[Patent Reference 4] Japanese Patent Application Laid-Open No. 2003-151332 (pages 2 and 3, FIG. 1)

Under the above circumstances, the present invention has an object of providing a mold for injection molding a light guide plate which suppresses formation of weld lines, sink marks, flow marks and warp and provides a product of injection molding exhibiting excellent quality without the necessity of steps of gate cutting and finishing and a process for efficiently producing a light guide plate having the above advantageous properties.

### DISCLOSURE OF THE INVENTION

As the result of intensive studies by the present inventors to achieve the above object, it was found that, in a mold for injection molding for forming a light guide plate having a face receiving incident light, a face opposite to the face receiving incident light, a face outputting light, a face reflecting light opposite to the face outputting light and two side faces by injection molding of a melted resin material, the object could be achieved by disposing a plurality of pin gates or film gates having a small area at the portion corresponding to the side face of the light guide plate, as the result of which viscosity of the melted resin material for molding was decreased by heat generated from shearing when the resin material for molding passed through the gates and was introduced into a cavity portion, the easiness of filling the cavity was improved due to the increase in the fluidity caused by the decrease in the viscosity, formation of weld lines and the like was suppressed, and furthermore, the necessity of the finishing step was eliminated due to easy gate cutting. The present invention has been completed based on such knowledge.

The present invention provides:

(1) A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,

wherein a plurality of pin gates and/or film gates for injecting the melted resin material for molding into the cavity portion are formed in portions corresponding to the side portions of the obtained light guide plate;

(2) A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,

wherein a plurality of pin gates and/or film gates for injecting the melted resin material for molding into the cavity portion are formed in portions corresponding to the side portions of the obtained light guide plate, and a room for balancing flow comprising an ear-shaped portion to which the melted resin material for molding is supplied is disposed between each gate and a sprue or a runner;

(3) A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,

wherein a plurality of pin gates and/or film gates for injecting the melted resin material for molding into the cavity portion are formed in portions corresponding to the side portions of the obtained light guide plate, a room for balancing flow comprising an ear-shaped portion to which the melted resin material for molding is supplied is disposed between each gate and a sprue or a runner, and an area of each gate is set so that a temperature of the melted resin material for molding introduced into the cavity portion through each gate is higher than a temperature of the melted resin material for molding supplied to each room for balancing flow by at least 5° C. due to heat generated from shearing when the melted resin material for molding passes through the gate;

(4) A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,

wherein a plurality of pin gates for injecting the melted resin material for molding into the cavity portion are formed in portions corresponding to the side portions of the obtained light guide plate, a room for balancing flow comprising an ear-shaped portion to which the melted resin material for molding is supplied is disposed between each pin gate and a sprue or a runner, and each area S (mm²) of the plurality of pin gates satisfies a relation expressed by equation [1]:
1.0×10⁻⁷×A×(L/n)≦S≦1.0×10⁻³×A×(L/n) [1]
when an area of the side face of the obtained light guide plate is represented by A (mm²), a length of a longer edge of the face receiving incident light is represented by L (mm), and a number of the pin gate is represented by n;
(5) A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,

wherein a plurality of film gates for injecting the melted resin material for molding into the cavity portion are formed in portions corresponding to the side portions of the obtained light guide plate, a room for balancing flow comprising an ear-shaped portion to which the melted resin material for molding is supplied is disposed between each film gate and a sprue or a runner, and each area S′ (mm²) of the plurality of film gates satisfies a relation expressed by equation [2]:
1.0×10⁻⁵×A×(L/n)≦S′≦1.0×10⁻²×A×(L/n) [2]
when an area of the side face of the obtained light guide plate is represented by A (mm²), a length of a longer edge of the face receiving incident light is represented by L (mm), and a number of the film gate is represented by n;
(6) The mold for injection molding a light guide plate according to any one of (1) to (5), wherein a same number, which is 1 or greater, of pin gates and/or film gates are formed at both side portions corresponding to the side faces of the obtained light guide plate;
(7) The mold for injection molding a light guide plate according to (6), wherein a same number, which is 1 or greater, of pin gates and/or film gates are formed at symmetrical positions at both side portions corresponding to the side faces of the obtained light guide plate;
(8) A process for producing a light guide plate which comprises using the mold described in any one of (1) to (7) and injecting a melted resin material for molding into the cavity portion of the mold;
(9) The process for producing a light guide plate according to (8), wherein the resin material for molding comprises a resin having an alicyclic structure; and
(10) The process for producing a light guide plate according to (8), wherein the resin material for molding comprises a methacrylic resin or a (meth)acrylic acid ester-aromatic vinyl compound copolymer.

### BRIEF DESCRIPTION OF THE DRAWINGS

FIG. 1 shows a diagram exhibiting a light guide plate for liquid crystal display devices.

FIG. 2 shows a diagram exhibiting an embodiment of the gate of the mold for injection molding a light guide plate of the present invention.

FIG. 3 shows a diagram exhibiting another embodiment of the gate of the mold for injection molding a light guide plate of the present invention.

FIG. 4 shows a diagram exhibiting a plan view of an example of the room for balancing flow shown in FIG. 2 from the side of the upper face of the mold.

FIG. 5 shows a diagram exhibiting a plan view of an example of the room for balancing flow shown in FIG. 3 from the side of the upper face of the mold. In the Figures, the mark 1 means a face receiving incident light, the mark 2 means a light source, the mark 3 means a face outputting light, the mark 4 means a face reflecting light, the marks 5 and 6 mean side faces, the mark 11 means a front side face of a cavity, the mark 12 means a rear side face of a cavity, the mark 13 means an upper face of a cavity, the mark 14 means a lower face of a cavity, the marks 15 and 16 mean side faces of a cavity, the marks 17 and 20 mean rooms for balancing flow, the mark 18 means a pin gate, the marks 19 and 22 mean inlets for supplying a material for molding, and the mark 21 means a film gate.

### THE MOST PREFERRED EMBODIMENT TO CARRY OUT THE INVENTION

The mold for injection molding a light guide plate of the present invention (hereinafter, referred to simply as “mold”, occasionally) comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion. A plurality of pin gates and/or film gates for injecting the melted resin material for molding into the cavity portion are formed in portions corresponding to the side portions of the obtained light guide plate.

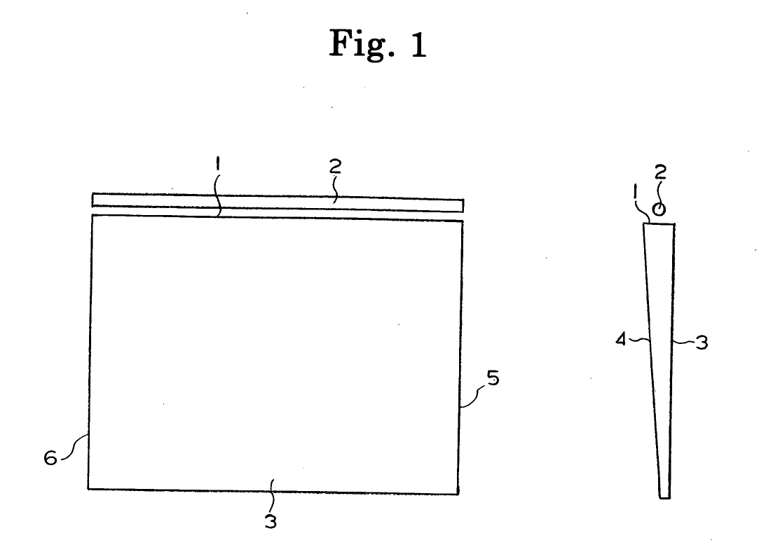

FIG. 1 shows a diagram exhibiting a light guide plate for liquid crystal display devices. The shape of the light guide plate produced in accordance with the process of the present invention is not limited to the shape shown in FIG. 1. For example, the shape may be a flat plate shape having a uniform thickness. The light guide plate shown in FIG. 1 is a transparent molded product having an approximately rectangular shape. The side face at the side of one of the longer edges has a greater thickness and used as the face receiving incident light 1. The side face at the side of the other longer edge facing the above side face has a smaller thickness, and the side face has an approximately wedge shape in viewing at the side of a shorter edge. In the vicinity of the face receiving incident light 1, a light source 2 such as a cold cathode ray tube and a light emitting diode is disposed and surrounded with a reflector. Light emitted from the light source 2 is incident on the face receiving incident light 1, repeats the total internal reflection in the light guide plate and is output from a face outputting light 3 into a liquid crystal display element as uniform light having no unevenness in luminance. On the face reflecting light 4 faced to the face outputting light 3, a fine prism pattern or a rough pattern is formed or a white reflection sheet is laminated to reflect light. On the face outputting light, a fine prism pattern or a rough pattern is formed or a light diffuser sheet or a prism sheet is laminated to provide light having no unevenness in luminance.

A back light device comprising a light guide plate to which the light source and the reflector are disposed and the reflection sheet, the light diffuser sheet and the prism sheet are laminated is attached to a liquid crystal display element and contained in a casing of a plastics or the like, and a complete liquid crystal display device can be obtained.

In the mold of the present invention, a plurality of pin gates and/or film gates are formed at a portion corresponding to one of the side faces (mark 5 in FIG. 1) and/or the other of the side faces (mark 6 in FIG. 1) of the light guide plate to be obtained. It is preferable that a room for balancing flow comprising an ear shaped portion to which a melted resin material for molding is supplied is disposed between each gate and a sprue or a runner.

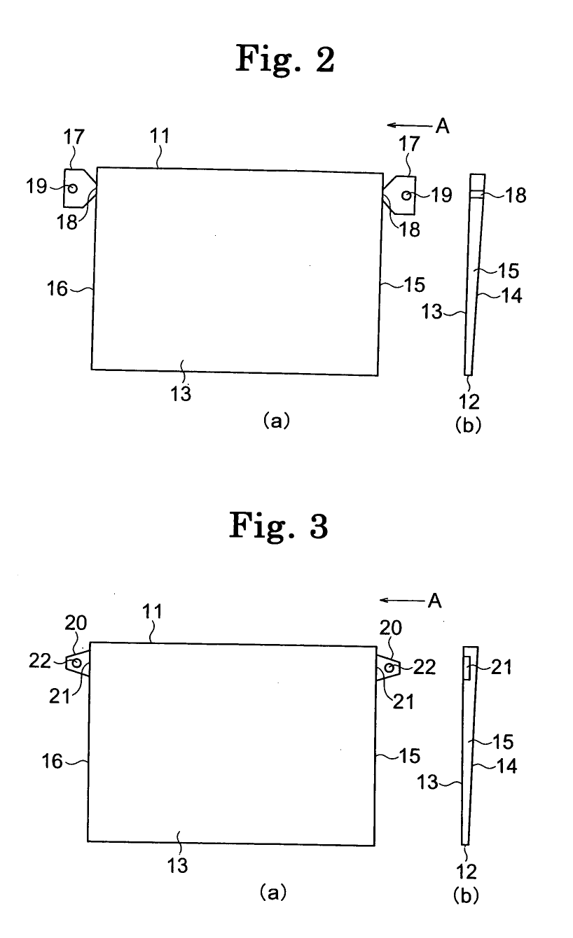

FIGS. 2 and 3 show diagrams exhibiting different embodiments of the gate of the mold for injection molding a light guide plate of the present invention.

FIG. 2(a) and FIG. 3(a) each show a plan view of the mold of the present invention. FIG. 2(b) and FIG. 3(b) each show a view of a side face 15 in FIG. 2(a) and FIG. 3(a), respectively, in the direction shown by A.

The molds shown in FIG. 2 and FIG. 3 each have, as the faces constituting a cavity, a face corresponding to the face outputting light (referred to as the upper face of the cavity, hereinafter) 13, a face corresponding to the face reflecting light (referred to as the lower face of the cavity, hereinafter) 14, a face corresponding to the face receiving incident light (referred to as the front side face of the cavity, hereinafter) 11, a face opposite to the front side face of the cavity (referred to as the rear side face of the cavity, hereinafter) 12 and two side faces opposite to each other (referred to as the side faces of the cavity, hereinafter) 15 and 16 of the light guide plate to be formed.

In the mold shown in FIG. 2, a pin gate 18 is formed on each of both side faces of the cavity 15 and 16 in the vicinity of the front side face of the cavity 11. In the present invention, examples of the shape of the pin gate include circular shapes, elliptical shapes, polygonal shapes and slit shapes. In the mold shown in FIG. 3, a film gate 21 is formed on each of both side faces of the cavity 15 and 16 in the vicinity of the front side face of the cavity 11. In FIG. 2, a room for balancing flow 17 comprising an ear shaped portion to which the melted resin material for molding is supplied via an inlet 19 is disposed between each pin gate 18 and a sprue or a runner. In FIG. 3, a room for balancing flow 20 comprising an ear shaped portion to which the melted resin material for molding is supplied via an inlet 22 is disposed between each film gate 21 and the sprue or a runner. The shape of the room for balancing flow 20 disposed in the mold of the present invention is not particularly limited as long as the room for balancing flow has a prescribed volume. For example, the room for balancing flow may have a shape such that the thickness remains constant in viewing from the front side of the cavity or a shape such that the thickness is tapered toward the film gate.

The room for balancing flow disposed in the mold of the present invention means a portion which is located between a sprue or a runner and a pin gate and/or a film gate and has an average linear flow rate in the room for balancing flow which is 0.99 times, preferably 0.7 times and more preferably 0.5 times the minimum value among the average linear flow rates at the sprue, the runner or the pin gate and/or the film gate or smaller. It is preferable that the room for balancing flow has a flat plate shape. The shape of the room for balancing flow in viewing from the side of the upper face of the mold is not particularly limited. For example, the shape may be a triangular shape, a quadrangular shape and a pentangular shape. It is preferable that the room for balancing flow can be contained in a space having lengths of edges of about 10 to 50 mm and a thickness of about 1 to 10 mm.

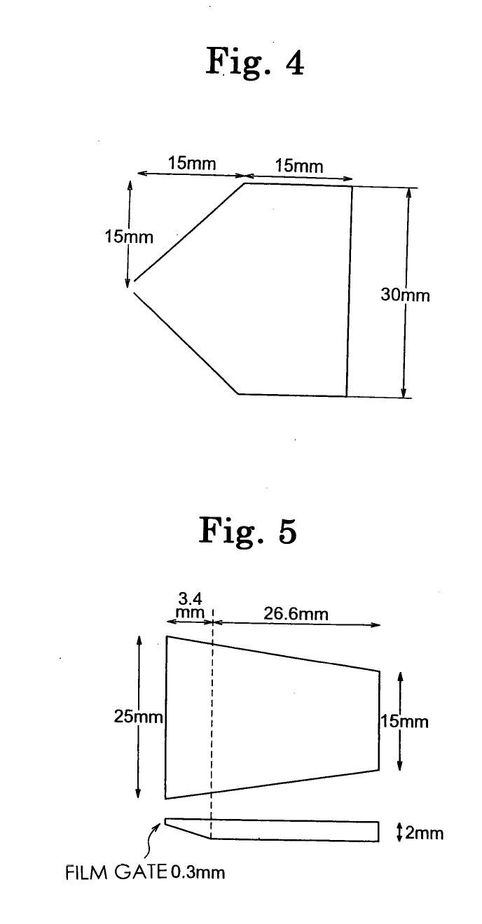

FIG. 4 shows a diagram exhibiting a plan view of an example of the room for balancing flow 17 shown in FIG. 2 from the side of the upper face of the mold. In this case, the thickness of the room for balancing flow is 2 mm. The pin gate has a size of 2 mm in the direction of the thickness and a width of 1 mm (in the vertical direction in FIG. 4).

FIG. 5 shows a diagram exhibiting a plan view of an example of the room for balancing flow 20 in FIG. 3 from the side of the upper face of the mold. In this case, the room for balancing flow is in a region having a length of 26.6 mm and a thickness of 2 mm. The film gate has a width of 25 mm and a thickness of 0.3 mm.

In the present invention, by disposing the room for balancing flow described above, the heat generation from shearing is stabilized, and the transcription on the face reflecting light and the face outputting light can be made uniformly. By supplying the resin material for molding into the room for balancing flow through a pin gate, the heat generation from shearing takes place at two positions, and the effect shown in the following can be exhibited to a greater degree.

When the injection molding is conducted with a melted resin material using a mold having a plurality of rooms for balancing flow and gates having a small area such as pin gates and film gates, the melted resin material for molding is supplied to the room for balancing flow via a sprue or a runner, passes through the gate having a small area such as the pin gate and the film gate and is injected into the cavity.

When the melted resin material for molding supplied from the room for balancing flow passes through the gate having a small area, the temperature of the material for molding is raised due to the heat generated from shearing under the squeezing effect, and the flow property of the melted resin material for molding is improved due to the decrease in the melt viscosity. As the result, the filling property into the cavity is improved, and formation of weld lines, sink marks, flow marks, poor transcriptions and warp can be suppressed. Thus, the high quality light guide plate exhibiting excellent optical property can be obtained.

In the present invention, it is preferable that the area of each gate is set so that the melted resin material for molding supplied into the cavity via each gate has a temperature higher than the temperature of the melted resin material for molding supplied to each room for balancing flow by at least 5° C. due to the generation of heat from shearing when the material passes through the gate. When the elevation of the temperature of the melted material for molding due to the generation of heat from shearing is smaller than 5° C., there is the possibility that the effect of improving the flow property of the material for molding is not sufficiently exhibited, and the object of the present invention is not achieved. It is preferable that the elevation of the temperature is 10° C. or greater and more preferably 15° C. or greater. The upper limit of the elevation of the temperature is, in general, about 150° C. when the decomposition of the resin by heating, the burning of the resin and the generation of gases are considered.

In the present invention, the room for balancing flow is disposed to obtain stable generation of heat from shearing. The volume of the room for balancing flow is not particularly limited. The volume is, in general, about 0.001×A×L to 0.2×A×L (mm³), preferably 0.002×A×L to 0.1×A×L (mm³), and more preferably 0.005×A×L to 0.05×A×L (mm³). A represents the area of the side face, and L represents the length of the longer edge of the face receiving incident light of the light guide plate to be obtained.

The generation of heat from shearing when the melted resin material for molding passes through the gate having a small area and is injected into the cavity depends on the area of the gate, the amount of flow of the material for molding passing through the gate per unit time, the viscosity of the material for molding and the shape of the gate. The major factors are the area of the gate and the amount of flow of the material for molding passing through the gate per unit time. The amount of flow of the material for molding passing through the gate per unit time is approximately decided by the volume of the light guide plate to be obtained and the number of the formed gate.

Therefore, in the present invention, it is preferable that each area S (mm²) of the plurality of pin gates satisfies the relation expressed by equation [1]:
1.0×10⁻⁷×A×(L/n)≦S≦1.0×10⁻³×A×(L/n) [1]
when the area of the side face of the obtained light guide plate is represented by A (mm²), the length of the longer edge of the face receiving incident light is represented by L (mm), and the number of the pin gate is represented by n.

When the area of each pin gate satisfies the above relation expressed by equation [1], excellent generation of heat from shearing can be obtained without adversely affecting the productivity. It is more preferable that each area S (mm²) of the plurality of pin gates satisfies the relation expressed by equation [1-a]:
1.0×10⁻⁶×A×(L/n)≦S≦1.0×10⁻⁴×A×(L/n) [1-a]
and most preferably the relation expressed by equation [1-b]:
3.0×10⁻⁶×A×(L/n)≦S≦3.0×10⁻⁴×A×(L/n) [1-b]

In the case of the film gate, it is preferable that each area S′ (mm²) of the plurality of film gates satisfies the relation expressed by equation [2]:
1.0×10⁻⁵×A×(L/n)≦S′≦1.0×10⁻²×A×(L/n) [2]
when the area of the side face of the obtained light guide plate is represented by A (mm²), the length of the longer edge of the face receiving incident light is represented by L (mm), and the number of the film gate is represented by n.

When the area of each film gate satisfies the above relation expressed by equation [2], excellent generation of heat from shearing can be obtained without adversely affecting the productivity. It is more preferable that each area S′ (mm²) of the plurality of film gates satisfies the relation expressed by equation [2-a]:
2.0×10⁻⁵×A×(L/n)≦S′≦7.0×10⁻³×A×(L/n) [2-a]
and most preferably the relation expressed by equation [2-b]:
3.0×10⁻⁵×A×(L/n)≦S′≦5.0×10⁻³×A×(L/n) [2-b]

In the present invention, the number of the gate is not particularly limited as long as the number is 2 or greater. It is preferable that the number is 2 to 6 from the standpoint of the balance between the cost of preparation of the mold and the effect. The position of the gate is not particularly limited. The gate may be formed at one side face alone or at both side faces of the cavity. It is preferable that the same number of the gate is formed at each side face so that the light guide plate having more excellent quality can be obtained. The position of the gate at the side face of the cavity is not particularly limited. The position may be close to an edge portion or close to the central portion of the side face of the cavity. It is preferable that the position is selected so that the light guide plate having the excellent quality can be obtained with stability. In particular, it is preferable that the gates are formed at symmetrical positions on both side faces.

In general, a plurality of gates tend to cause formation of weld lines. The formation of weld lines can be prevented by using the mold of the present invention.

When a pin gate is formed, the shape of the pin gate is not particularly limited and may be any of circular shapes, elliptical shapes, polygonal shapes and slit shapes. A plurality of the pin gates may have the same shape or shapes different from each other. Pin gates and film gates may be formed in combination. The material of molding solidified at the portion of the pin gate or the film gate can be easily cut off since the portion connecting the light guide plate as the product of molding and the gate has a very small sectional area.

Therefore, in accordance with the present invention, the cutting can be achieved in a very short time by using a simple cutting tool such as a hot cutter in the step of taking out the product, and the light guide plate can be produced with a great productivity. The mark does not substantially affect the optical properties of the light guide plate since the mark formed by the pin gate or the film gate is small and is located on the side face of the light guide plate even when the mark is present.

In the present invention, when the pin gate is used, it is preferable that a gate land is formed. The length of the gate land is preferably 0.2 to 2 mm and more preferably 0.5 to 1.5 mm. When the length of the gate land is shorter than 0.2 mm, there is the possibility that a portion of the light guide plate is cleaved off when the product obtained by the molding is cut off from the gate portion. When the length of the gate exceeds 2 mm, there is the possibility that the product obtained by the molding is cut off at the gate portion, and the gate portion remains as a protrusion on the light guide plate.

The present invention also provides a process for producing a light guide plate comprising using the mold of the present invention described above and injecting a melted resin material for molding into the cavity portion of the above mold.

In the present invention, a material comprising a thermoplastic resin is used as the resin material for molding.

The thermoplastic resin used in the present invention is not particularly limited. Examples of the thermoplastic resin include resins having an alicyclic structure, methacrylic resins, polycarbonates, polystyrene, acrylonitrile-styrene copolymers, (meth)acrylic acid ester-aromatic vinyl compound copolymers which are preferably methyl methacrylate-styrene copolymer resins, ABS resins and polyether sulfones. Among these resins, resins having an alicyclic structure, methacrylic resins and (meth)acrylic acid ester-aromatic vinyl compound copolymers are preferable. Since the resin having an alicyclic structure has excellent fluidity of the melted resin, the cavity of the mold can be filled under a small pressure of injection using pin gates or film gates. Since the resin having an alicyclic structure has a very small moisture absorption, excellent dimensional stability is exhibited, and warp does not arise in the light guide plate. Since the specific gravity is small, the weight of the light diffusion plate can be decreased. When the resin having an acyclic structure is used in the process for producing a light guide plate of the present invention, the formation of weld lines can be suppressed in comparison with the use of other resins.

Examples of the polymer resin having an alicyclic structure include polymer resins having an alicyclic structure in the main chain or in side chains. The polymer resin having an alicyclic structure in the main chain is more preferable due to the excellent mechanical strength and heat resistance. As the alicyclic structure, saturated alicyclic hydrocarbon structures are preferable. The structure preferably has 4 to 30 carbon atoms, more preferably 5 to 20 carbon atoms and most preferably 5 to 15 carbon atoms. The content of the repeating unit having the alicyclic structure in the polymer resin having an alicyclic structure is preferably 50% by weight or greater, more preferably 70% by weight or greater and most preferably 90% by weight or greater.

Examples of the polymer resin having an alicyclic structure include ring-opening polymers and ring-opening copolymers of monomers having the norbornene structure and hydrogenation products thereof; addition polymers and addition copolymers of monomers having the norbornene structure and hydrogenation products thereof; polymers of a monomer having a cyclic olefin structure having a single ring and hydrogenation products thereof; polymers of a monomer having a cyclic conjugated diene structure and hydrogenation products thereof; polymers and copolymers of a monomer having a vinyl alicyclic hydrocarbon structure and hydrogenation products thereof; and hydrogenation products of polymers and copolymers having a vinyl aromatic hydrocarbon structure at unsaturated bond portions including aromatic rings. Among these polymer resins, hydrogenation products of polymers of monomers having the norbornene structure and hydrogenation products of polymers and copolymers having a vinyl aromatic hydrocarbon structure at unsaturated bond portions including aromatic rings are preferable due to the excellent mechanical strength and heat resistance.

Methacrylic resins can be preferably used for the light guide plate of liquid crystal display devices since methacrylic resins have excellent transparency and the formation of cracks is suppressed due to the excellent toughness. Examples of the methacrylic resin include methacrylic resin materials for molding comprising 80% or more of a methyl methacrylate polymer as specified in Japanese Industrial Standard K 6717. Among the methacrylic resins specified in the above standard, methacrylic resins classified by the classification code of 100-120 which have a Vicat softening point of 96 to 100° C. and a melt flow rate of 8 to 16 are more preferable due to the suitable fluidity and strength.

The (meth)acrylic ester-aromatic vinyl compound copolymer can be obtained by copolymerization of a monomer having an aromatic vinyl structure and a monomer having a (meth)acrylic acid alkyl ester structure having a lower alkyl group.

Examples of the monomer having an aromatic vinyl structure include styrene, α-methylstyrene, m-methylstyrene, p-methylstyrene, o-chlorostyrene and p-chlorostyrene. The monomer having an aromatic vinyl structure may be used singly or in combination of two or more.

Examples of the monomer having a (meth)acrylic acid alkyl ester structure having a lower alkyl group include (meth)acrylic acid alkyl esters having an alkyl group having 1 to 4 carbon atoms and preferably 1 or 2 carbon atoms. Specific examples include methyl methacrylate, ethyl methacrylate, methyl acrylate and ethyl acrylate. The monomer having a (meth)acrylic acid alkyl ester structure having a lower alkyl group may be used singly or in combination of two or more.

As for the relative amounts of the components constituting the above copolymer, the content of the monomer having an aromatic vinyl structure is in the range of 95 to 5% by weight and the content of the monomer having a (meth)acrylic acid alkyl ester structure having a lower alkyl group is in the range of 5 to 95% by weight. It is preferable from the standpoint of the optical properties and the molding property that the content of the monomer having an aromatic vinyl structure is in the range of 60 to 20% by weight and the content of the monomer having a (meth)acrylic acid alkyl ester structure having a lower alkyl group is in the range of 80 to 40% by weight.

In the present invention, the resin material for molding can be used for the injection molding, where necessary, after other polymers, various compounding ingredients and fillers are added singly or in combination of two or more. Examples of the other polymer include rubbers and resins such as polybutadiene and polyacrylates.

Examples of the compounding ingredients include antioxidants, ultraviolet light absorbents, light stabilizers, near infrared light absorbents, coloring agents such as dyes and pigments, lubricants, plasticizers, antistatic agents and fluorescent whitening agents. It is not always necessary that the light guide plate obtained in accordance with the process of the present invention is transparent. The ability of scattering light may be provided by adding a light diffusing agent such as fine particles of polystyrene-based polymers, polysiloxane-based polymers and crosslinked products of these polymers, fluororesins, barium sulfate, calcium carbonate, silica and talc. Among these agents, fine particles of polystyrene-based polymers, polysiloxane-based polymers and crosslinked products of these polymers are preferable due to the excellent dispersion and heat resistance and the absence of yellowing during the molding.

In the present invention, the injection molding is conducted at a resin temperature of Tg+100(° C.) to Tg+200(° C.) and preferably Tg+150(° C.) to Tg+200(° C.) and at a mold temperature of Tg−50(° C.) to Tg(° C.) and preferably Tg−30(° C.) to Tg(° C.). Tg means the glass transition temperature of the thermoplastic resin used for the molding. The rate of injection is 20 to 200 mm/sec and preferably 40 to 180 mm/sec.

The light guide plate obtained in accordance with the process of the present invention can be used also as the light guide plate unit of the planar light source device of the tandem type surely providing a broad light emitting area which is described in Japanese Patent Application Laid-Open No. Heisei 11 (1999)-288611.

### EXAMPLES

The present invention will be described more specifically with reference to examples in the following. However, the present invention is not limited to the examples.

The evaluations in Examples and Comparative Examples were conducted in accordance with the following methods.

(1) Cycle Time

The time necessary for steps including injection→pressure holding →cooling→taking out→cutting off gate portions was used as the cycle time.

(2) Appearance

The presence or the absence of weld lines and the condition of the transcription of the entire face were examined by visual observation.

(3) Condition of Molding

A back light device was prepared using a light guide plate. A lamp was lighted, and dark lines and bright lines were examined. The evaluation was made in accordance with the following criterion:
good: no dark lines or bright lines found.
poor: dark lines or bright lines found.

### Example 1

A light guide plate was prepared in accordance with the injection molding using a resin having an alicyclic structure [manufactured by NIPPON ZEON Co., Ltd.; ZEONOR 1060R].

A mold which had a length of the shorter edge of 220 mm, a length of the longer edge of 290 mm, a thickness of the side face at the side of the longer edge corresponding to the face receiving incident light of 2.2 mm, a thickness of the side face at the side of the longer edge corresponding to the face opposite to the face receiving incident light of 0.7 mm, film gates having a width of 25 mm and a thickness of 0.3 mm formed on the both side faces at the side of the shorter edge each at the position separated from the face receiving incident light by 5 mm and a room for balancing flow having a volume of 1,200 mm³ such as that shown in FIG. 5, was used.

When the area of the gate was represented by S′ (mm²), the area of the side face of the light guide plate was represented by A (mm²), the length of the longer edge of the face receiving incident light was represented by L (mm), and the volume of the room for balancing flow was represented by V (mm³), A·L/n=46255, S=7.5 mm², and V/(A·L)=0.013.

Using an injection molding machine having a diameter of screw of 70 mm and a mold clamping force of 3,430 kN, the temperature of the melted resin was set at 270° C., and the temperature of the mold was set at 85° C. The injection molding was conducted under a molding cycle of 40 seconds as the total of the injection for 1 second, the pressure holding at 20 MPa after the injection for 7 seconds, the cooling for 27 seconds thereafter and the taking out for 5 seconds. Since the gate portion was thin, the gate was cut off by a hot cutter attached to the mold within the time for the taking out.

The obtained light guide plate had no sink marks, and the condition of transcription was good over the entire face. The results of evaluations are shown in Table 1.

### Example 2

A light guide plate was prepared in accordance with the same procedures as those conducted in Example 1 except that a mold which had a length of the shorter edge of 220 mm, a length of the longer edge of 290 mm, a thickness of the side face at the side of the longer edge corresponding to the face receiving incident light of 2.2 mm, a thickness of the side face at the side of the longer edge corresponding to the face opposite to the face receiving incident light of 0.7 mm, pin gates having a thickness of 2 mm, a width of 1 mm and a length of the gate land of 0.5 mm formed on both side faces at the side of the shorter edge each at the position separated from the face receiving incident light by 20 mm and a room for balancing flow having a volume of 1,350 mm³ such as that shown in FIG. 4, was used. The obtained light guide plate had no sink marks, and the condition of transcription was good over the entire face.

When the area of the gate was represented by S (mm²), the area of the side face of the light guide plate was represented by A (mm²), the length of the longer edge of the face receiving incident light was represented by L (mm), and the volume of the room for balancing flow was represented by V (mm³), A·L/n=46255, S=2 mm², and V/(A·L)=0.014. The results of evaluations are shown in Table 1.

### Example 3

A light guide plate was prepared in accordance with the same procedures as those conducted in Example 1 except that a methacrylic resin [manufactured by ASAHI KASEI Co., Ltd.; DELPET 70NHX] was used in place of the resin having an alicyclic structure. The obtained light guide plate had no sink marks, and the condition of transcription was good over the entire face. Warp arose when the cooling time was 27 seconds. The cooling time was extended to 32 seconds, and a light guide plate having no warp was obtained. The cycle time was 45 seconds. The results of evaluations are shown in Table 1.

### Comparative Example 1

A light guide plate was prepared in accordance with the injection molding using a resin having an alicyclic structure [manufactured by NIPPON ZEON Co., Ltd.; ZEONOR 1060R].

A mold which had a length of the shorter edge of 220 mm, a length of the longer edge of 290 mm, a thickness of the side face at the side of the longer edge corresponding to the face receiving incident light of 2.2 mm, a thickness of the side face at the side of the longer edge corresponding to the face opposite to the face receiving incident light of 0.7 mm, and fan gates having a width of 100 mm and a thickness of 1 mm formed on the both side faces at the side of the shorter edge each at the position separated from the face receiving incident light by 5 mm, was used.

Using an injection molding machine having a diameter of screw of 70 mm and a mold clamping force of 3,430 kN, the temperature of the melted resin was set at 270° C., and the temperature of the mold was set at 85° C. The injection molding was conducted for 1 second, and the pressure was kept at 20 MPa for 7 seconds after the injection. Then, the cooling was conducted. The temperature of the resin decreases slowly due to the great thickness of the fan gate portion, and it took 37 seconds for solidification of the fan gate portion (the time required for the cooling: 37 seconds). The product of molding was taken out in 5 seconds. The gate portion formed with the fan gate was thick unlike the gate portion formed with the film gate, and the cutting was not easy. It took 10 seconds to cut off the gate portion after the product was taken out. The cycle time was 60 seconds.

Although the obtained light guide plate had no sink marks, weld lines were formed at the central portion of the light guide plate, and poor transcription was also found in observation. The result of the evaluations are shown in Table 1

TABLE 1

| | | | | | Condi- |
|---|---|---|---|---|---|
| | | | | Cycle | tion |
| | Material for | | Appearance | time | of |
| | molding | Gate | (weld lines) | (second) | molding |
| Example 1 | alicyclic | film gates | none | 40 | good |
| | structure | from ear | | | |
| | | portion | | | |
| Example 2 | alicyclic | pin gates | none | 40 | good |
| | structure | from ear | | | |
| | | portion | | | |
| Example 3 | methacrylic | film gates | slightly | 45 | good |
| | | from ear | found | | |
| | | portion | | | |
| Com- | alicyclic | fan gates | found | 60 | poor |
| parative | structure | from front | | | (dark |
| Example 1 | | side face | | | around |
| | | | | | weld |
| | | | | | lines) |

### INDUSTRIAL APPLICABILITY

By using the mold of the present invention and in accordance with the process of the present invention, the formation of weld lines, sink marks, flow marks, poor transcription and warp are suppressed, and the product of injection molding which exhibits excellent quality as the light guide plate for liquid crystal display devices can be produced efficiently without the necessity of steps of gate cutting and finishing.

1. A mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion,
wherein a plurality of pin gates and/or film gates for injecting the melted resin material for molding into the cavity portion are formed in portions corresponding to the side portions of the obtained light guide plate.

2. The mold for injection molding a light guide plate according to claim 1,
wherein a room for balancing flow comprising an ear-shaped portion to which the melted resin material for molding is supplied is disposed between each gate and a sprue or a runner.

3. The mold for injection molding a light guide plate according to claim 2,
wherein an area of each gate is set so that a temperature of the melted resin material for molding introduced into the cavity portion through each gate is higher than a temperature of the melted resin material for molding supplied to each room for balancing flow by at least 5° C. due to heat generated from shearing when the melted resin material for molding passes through the gate.

4. The mold for injection molding a light guide plate according to claim 2, wherein the plurality of pin gates and/or film gates is a plurality of pin gates
and wherein each area S (mm²) of the plurality of the pin gates satisfies a relation expressed by equation [1]:
1.0×10⁻⁷×A×(L/n)≦S≦1.0×10⁻³×A×(L/n) [1]
when an area of the side face of the obtained light guide plate is represented by A (mm²), a length of a longer edge of the face receiving incident light is represented by L (mm), and a number of the pin gate is represented by n.

5. The mold for injection molding a light guide plate according to claim 2, wherein the plurality of pin gates and/or film gates is a plurality of film gates
and wherein each area S′ (mm²) of the plurality of film gates satisfies a relation expressed by equation [2]:
1.0×10⁻⁵×A×(L/n)≦S′≦1.0×10⁻²×A×(L/n) [2]
when an area of the side face of the obtained light guide plate is represented by A (mm²), a length of a longer edge of the face receiving incident light is represented by L (mm), and a number of the film gate is represented by n.

6. The mold for injection molding a light guide plate according to claim 1, wherein a same number, which is 1 or greater, of pin gates and/or film gates are formed at both side portions corresponding to the side faces of the obtained light guide plate.

7. The mold for injection molding a light guide plate according to claim 6, wherein a same number, which is 1 or greater, of pin gates and/or film gates are formed at symmetrical positions at both side portions corresponding to the side faces of the obtained light guide plate.

8. A process for producing a light guide plate which comprises:
using a mold for injection molding a light guide plate which comprises a fixed mold, a moving mold and a cavity portion formed by fitting the fixed mold and the moving mold to each other and is used for forming the light guide plate having a face receiving incident light, a face opposite to the face receiving incident light, a face outputting light, a face reflecting light opposite to the face outputting light and two side faces by injection of a melted resin material for molding into the cavity portion, wherein a plurality of pin gates and/or film gates for injecting the melted resin material for molding into the cavity portion are formed in portions corresponding to the side portions of the obtained light guide plate, and
injecting a melted resin material for molding into the cavity portion of the mold.

9. The process for producing a light guide plate according to claim 8, wherein the resin material for molding comprises a resin having an alicyclic structure.

10. The process for producing a light guide plate according to claim 8, wherein the resin material for molding comprises a methacrylic resin or a (meth)acrylic acid ester-aromatic vinyl compound copolymer.

11. The process for producing a light guide plate according to claim 8, wherein a room for balancing flow comprising an ear-shaped portion to which the melted resin material for molding is supplied is disposed between each gate and a sprue or a runner of the mold.

12. The process for producing a light guide plate according to claim 8, wherein an area of each gate of the mold is set so that a temperature of the melted resin material for molding introduced into the cavity portion through each gate is higher than a temperature of the melted resin material for molding supplied to each room for balancing flow by at least 5° C. due to heat generated from shearing when the melted resin material for molding passes through the gate.

13. The process for producing a light guide plate according to claim 8, wherein the plurality of pin gates and/or film gates of the mold is a plurality of pin gates, and wherein each area S (mm²) of the plurality of the pin gates satisfies a relation expressed by equation [1]:
1.0×10⁻⁷×A×(L/n)≦S≦1.0×10⁻³×A×(L/n) [1]
when an area of the side face of the obtained light guide plate is represented by A (mm²), a length of a longer edge of the face receiving incident light is represented by L (mm), and a number of the pin gate is represented by n.

14. The process for producing a light guide plate according to claim 8, wherein the plurality of pin gates and/or film gates of the mold is a plurality of film gates, and wherein each area S′ (mm²) of the plurality of the film gates satisfies a relation expressed by equation [2]:
1.0×10⁻⁵×A×(L/n)≦S′≦1.0×10⁻²×A×(L/n) [2]
when an area of the side face of the obtained light guide plate is represented by A (mm²), a length of a longer edge of the face receiving incident light is represented by L (mm), and a number of the film gate is represented by n.
